(19) United States
(12) Patent Application Publication
(10) Pub. No.: US 2013/0201522 A1
(43) Pub. Date: Aug. 8, 2013

(54) NETWORK PRINTER MANAGEMENT SYSTEM, NETWORK PRINTER MANAGEMENT APPARATUS, AND METHOD FOR CONTROLLING THE SAME

(71) Applicant: CANON KABUSHIKI KAISHA, Tokyo (JP)

(72) Inventor: Toshio Ohashi, Chigasaki-shi (JP)

(73) Assignee: CANON KABUSHIKI KAISHA, Tokyo (JP)

(21) Appl. No.: 13/745,455

(22) Filed: Jan. 18, 2013

(30) Foreign Application Priority Data
Feb. 8, 2012 (JP) 2012-025534

(51) Int. Cl. G06F 3/12

(52) U.S. Cl. CPC G06F 3/1296
USPC 358/1.15

(57) ABSTRACT

In a network printer management apparatus, an inquiry regarding whether there exists a network printer that can execute a print job that was transmitted from a client computer is received from a print server. A network printer that can execute the print job and for which the distance from the client computer and a network printer power consumption amount satisfy a predetermined condition is then specified. If a network printer was specified, the print server is instructed to transfer the print job to that network printer. If a network printer was not specified, the print server is instructed to delay the transfer of the print job.

### BACKGROUND OF THE INVENTION

1. Field of the Invention

The present invention relates to a network printer management system, a network printer management apparatus, and a method for controlling the same.

2. Description of the Related Art

Conventionally, a system has been proposed in which the power consumption amount of a network printer is converted into a CO2 emission amount, and a print job is output to an alternate network printer that can perform printing if the converted CO2 emission amount exceeds an emission amount upper limit value, (e.g., see Japanese Patent Laid-Open No. 2011-150593).

A system has also been proposed in which, in an open office, the printer that is to perform printing is selected based on the user's seated location, and a print job is output to the selected printer (e.g., see Japanese Patent Laid-Open No. 2010-86488).

However, conventional systems have not been able to select an output destination printer for a print job while suppressing the peak value of the amount of network printer power consumption (i.e., realizing peak reduction) and also taking into consideration the distance from the user's seated location.

### SUMMARY OF THE INVENTION

The present invention provides a system and a method that enable specifying a printer that is to perform printing while realizing a reduction in the peak value of the amount of network printer power consumption and also taking into consideration the distance from the user's seated location.

According to an aspect of the present invention, a network printer management apparatus comprises: a reception unit that receives, from a print server, an inquiry regarding whether there exists a network printer that can execute a print job that was transmitted from a client computer; a specification unit that specifies a network printer that can execute the print job and for which the distance from the client computer and a network printer power consumption amount satisfy a predetermined condition; and an instruction unit that, if a network printer was specified by the specification unit, instructs the print server to transfer the print job to the network printer, and if a network printer was not specified by the specification unit, instructs the print server to delay the transfer of the print job.

According to the present invention, it is possible to output a print job after specifying a printer that is to perform printing while realizing a reduction in the peak value of the amount of network printer power consumption and also taking into consideration the distance from the user's seated location.

Further features of the present invention will become apparent from the following description of exemplary embodiments with reference to the attached drawings.

### BRIEF DESCRIPTION OF THE DRAWINGS

FIG. 1 is a diagram showing a hardware configuration of a network printer management system.

FIG. 2 is a diagram showing a software configuration of the network printer management system.

FIG. 3 is a diagram showing a configuration of tables in a database server service module.

FIG. 4 is a flowchart showing processing performed by a client computer.

FIG. 5 is a diagram showing an example of a screen for setting an output destination printer range.

FIG. 6 is a diagram showing an example of a screen for confirming the output destination printer.

FIG. 7 is a diagram showing a floor map in which the location of an output destination printer is displayed by an icon.

FIG. 8 is a flowchart showing processing performed by a print server.

FIG. 9 is a flowchart showing processing performed by an application server.

### DESCRIPTION OF THE EMBODIMENTS

Hereinafter, an embodiment for carrying out the invention will be described in detail with reference to the drawings. The description of the present embodiment is given taking the example of an application server as a management apparatus that manages multiple network printers that are connected to a network. Note that the term “network printer” encompasses a multi-function peripheral (MFP) that has a printing function, an image forming apparatus, a printing apparatus, and the like.

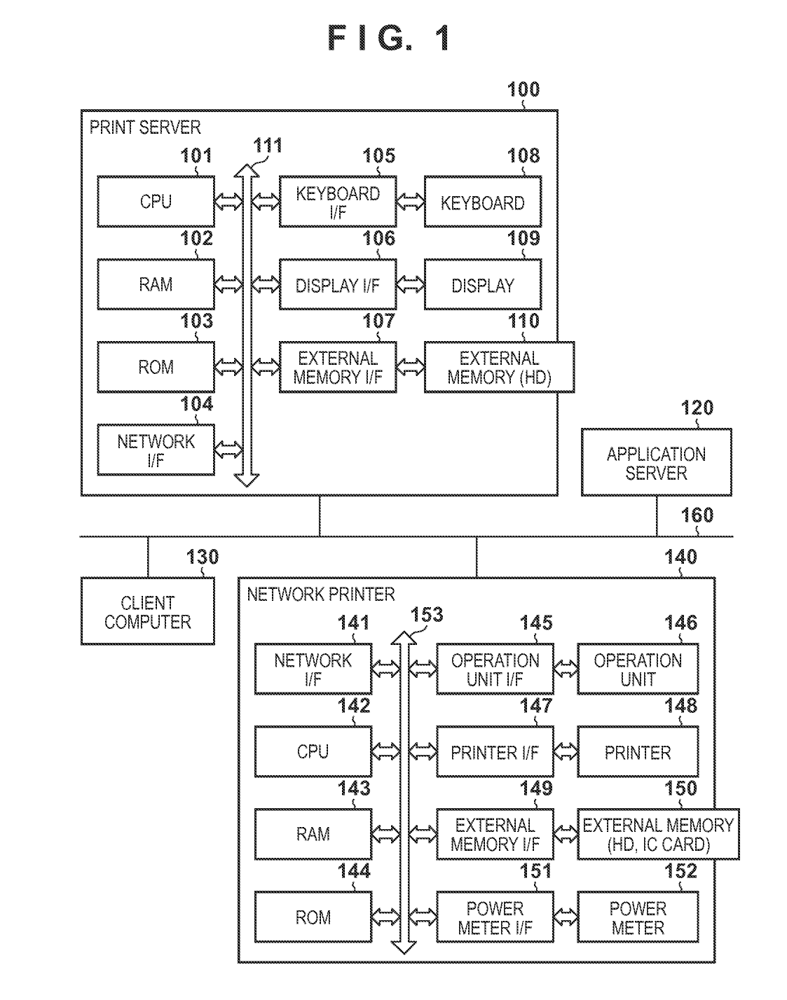

First, the system configuration of a network printer management system of the present embodiment and the hardware configurations of apparatuses that configure this system will be described with reference to the block diagram shown in FIG. 1.

The network printer management system is configured by a print server 100, an application server 120, a client computer 130, and a network printer 140, which are connected to each other via a network 160. Note that the print server 100, the application server 120, and the client computer 130 have configurations similar to that of a general-purpose computer. Also, the hardware configurations of the application server 120 and the client computer 130 will not be described since they are similar to that of the print server 100. Furthermore, although only one network printer 140 is shown in FIG. 1, multiple network printers may be connected in the system.

In the print server 100, a CPU 101 executes processing based on an application program or the like that is stored in a ROM 103, an external memory 110, or the like, and also performs overall control of devices that are connected to a system bus 111. The CPU 101 also opens various types of registered windows and executes various types of data processing based on commands issued by a mouse cursor or the like (not shown) on a display 109.

A RAM 102 is a memory that functions as a main memory, a work area, and the like for the CPU 101, and is used when the CPU 101 executes processing in accordance with a program. The ROM 103 is a read-only memory that functions as a storage area for a basic I/O program and the like. An operation system (OS), which is a control program executed by the CPU 101, and the like are stored in the ROM 103, the external memory 110, or the like. The ROM 103, the external memory 110, or the like also stores files and other data that are used during processing executed based on the above-mentioned application program or the like.

A network I/F 104 is connected to the network 160 and controls network communication. A keyboard I/F 105 controls input from a keyboard 108 and a pointing device (not shown). A display I/F 106 controls display performed by the display 109. An external memory I/F 107 controls access to the external memory 110, which is a high-capacity hard disk (HD) or the like. The external memory 110 stores a boot program, various types of applications, user files, editing files, and the like.

The print server 100 operates in a state in which the CPU 101 is executing the basic I/O program and the OS written to the ROM 103 and/or the external memory 110. Here, the basic I/O program is written to the ROM 103, and the OS is written to the ROM 103 or the external memory 110. When the computer power supply is switched on, the OS is written from the ROM 103 or the external memory 110 to the RAM 102 by an initial program loading function in the basic I/O program, and then operation of the OS is started. Also, the system bus 111 is a bus that interconnects units in the print server 100.

In the network printer 140, a network I/F 141 is connected to the network 160 and controls network communication. Based on a control program or the like, a CPU 142 outputs an image signal as output information to a printer 148 via a printer I/F 147 that is connected to a system bus 153. Note that the control program is stored in a ROM 144, an external memory 150, or the like. The CPU 142 can also perform processing for communication with a computer via the network I/F 141, and can notify the application server 120 of information and the like in the network printer 140. The CPU 142 furthermore executes processing based on an application program or the like that is stored in the ROM 144, the external memory 150, or the like.

A RAM 143 functions as a main memory, a work area, and the like for the CPU 142, is used when the CPU 142 executes processing in accordance with a program, and has a configuration in which the memory capacity can be expanded with an optional RAM that is connected to an expansion port (not shown). The RAM 143 is also used as an output information development area, an environmental data storage area, an NVRAM, and the like. The ROM 144 is a read-only memory that functions as a storage area for a basic I/O program and the like. The control program executed by the CPU 142, font data used when generating output information, information used in the network printer 140, and the like are stored in the ROM 144 and/or the external memory 150.

An operation unit I/F 145 is an interface with an operation unit 146, and outputs image data that is to be displayed to the operation unit 146. The operation unit I/F 145 also receives information that was input by a user via the operation unit 146. The operation unit 146 corresponds to, for example, an operation panel that is configured by switches for operations, an LED display, and the like. A printer I/F 147 outputs an image signal as output information to the printer 148 (printer engine). An external memory I/F (memory controller) 149 controls access to the external memory 150, which is a hard disk (HD), an IC card, or the like.

Also, the number of external memories is not limited to one, but rather a configuration is possible in which at least one or more is provided, and it is possible to connect multiple cards that store optional fonts in addition to built-in fonts, and external memories that store programs for interpreting different printer control languages. A configuration is also possible in which an NVRAM (not shown) is provided, and printer mode setting information from the operation unit 146 is stored in the NVRAM.

A power meter I/F 151 controls an interface with a power meter 152 and acquires the numerical value of a power consumption amount measured by the power meter 152. Also, a system bus 153 is a bus that interconnects units in the network printer 140.

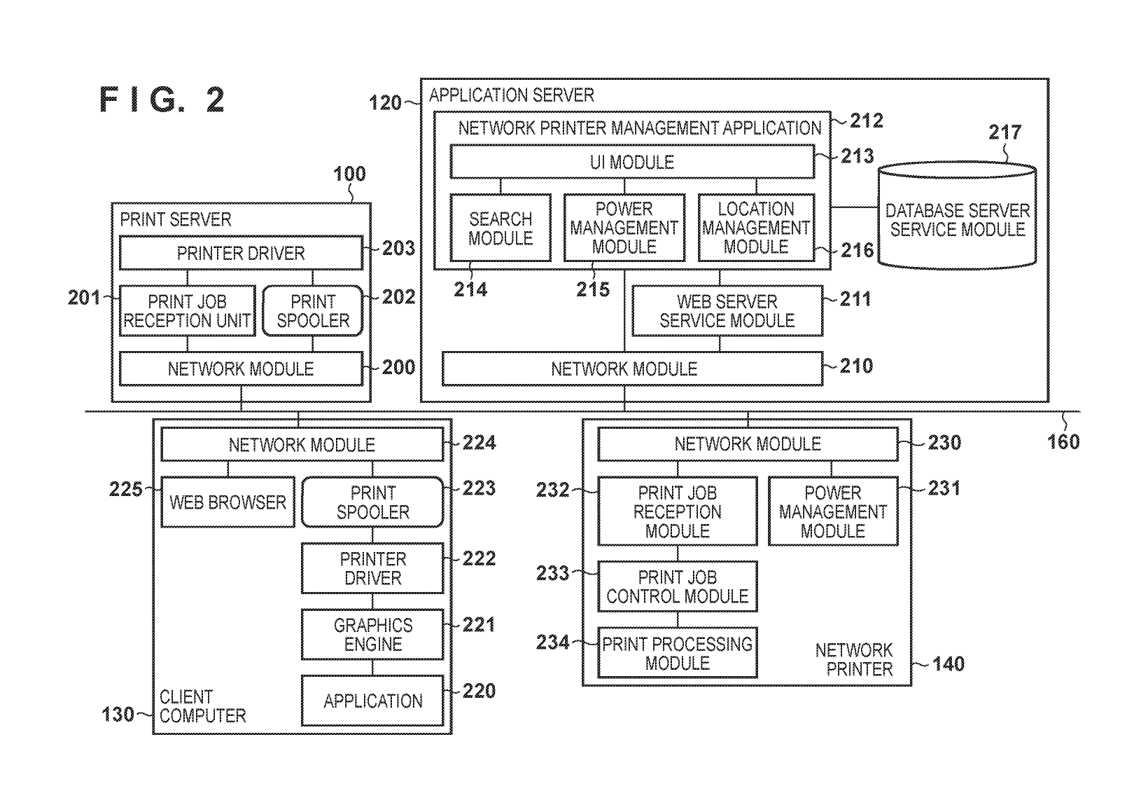

Next, the software configuration of the network printer management system of the present embodiment will be described with reference to the block diagram shown in FIG. 2. A description of the software configuration of the print server 100 will be given first.

In the print server 100, a network module 200, a print job reception unit 201, a print spooler 202, and a printer driver 203 are stored as files in the external memory 110. These constituent elements are program modules that are loaded to the RAM 102 at the time of execution and then executed by the OS or module that is to use them. The printer driver 203 can be added to the external memory 110 via a CD-ROM (not shown) or the network 160. The network module 200 controls network communication with the application server 120, the client computer 130, or the network printer 140 using an arbitrary communication protocol. The print job reception unit 201 receives a print job that was transmitted from the client computer 130. The received print job is transmitted to the printer driver 203. The print spooler 202 successively transmits print jobs to the network printer 140 via the network module 200. The printer driver 203 transmits a print job that was received from the print job reception unit 201 to the print spooler 223 as necessary.

The following describes the software configuration of the application server 120. A network module 210, a web server service module 211, and a network printer management application 212 are stored as files in the external memory 110. These constituent elements are program modules that are loaded to the RAM 102 at the time of execution and then executed by the OS or module that is to use them. The network printer management application 212 can be added to the external memory 110 via a CD-ROM (not shown) or the network 160.

The network module 210 controls network communication with the print server 100, the client computer 130, or the network printer 140 using an arbitrary communication protocol. The web server service module 211 provides a service for transmitting an HTTP response when an HTTP request is received from a web browser 225 of the client computer 130. Web page data that is stored in the external memory 110 may be transmitted as the HTTP response, for example. Alternatively, a UI module 213 of the network printer management application 212 may be requested to generate an HTTP response.

The network printer management application 212 is an application that manages the network printer 140, which is connected to the application server 120 via the network 160. The network printer management application 212 is implemented as, for example, a program for executing processing in response to a request for a web page provided by the web server service module 211. In this way, a web application for managing the network printer 140 is realized by the network printer management application 212 together with the web server service module 211.

Also, in the network printer management application 212, the UI module 213 generates an HTTP response in response to a request from the web server service module 211. The UI module 213 also receives user input information that was transmitted from the web browser 225 of the client computer 130, and invokes modules as necessary. Examples of modules invoked by the UI module 213 include a search module 214, a power management module 215, and a location management module 216. Note that the UI module 213 may invoke other modules.

The search module 214 searches for the network printer 140, which is connected to the application server 120 via the network 160, using an arbitrary communication protocol. Examples of the communication protocol used in the search performed by the search module 214 include SNMP (Simple Network Management Protocol) and SLP (Service Location Protocol). Another communication protocol such as WS-Discovery (Web Services Dynamic Discovery) may be used. Upon finding the network printer 140, the search module 214 acquires device information from the network printer 140 and stores it in a network printer management table 300 in a database server service module 217.

The power management module 215 acquires power consumption amount information from the network printer 140. Power consumption amount information is, for example, information indicating the amount of power consumed by the network printer 140 per unit of time. The power management module 215 acquires the power consumption amount information via a power management module 231 in the network printer 140. The location management module 216 manages location information of the client computer 130 and the network printer 140. Location information is, for example, information indicating the latitude, the longitude, the altitude, and the like of the installation location of the client computer 130 and the network printer 140. The location information is managed in a printer location management table 304 and a client computer location management table 305 in the database server service module 217.

The database server service module 217 manages data, and also stores and retrieves data in accordance with a request from another module. The database server service module 217 may be provided in a device other than the application server 120 as long as it can be accessed from the network printer management application 212.

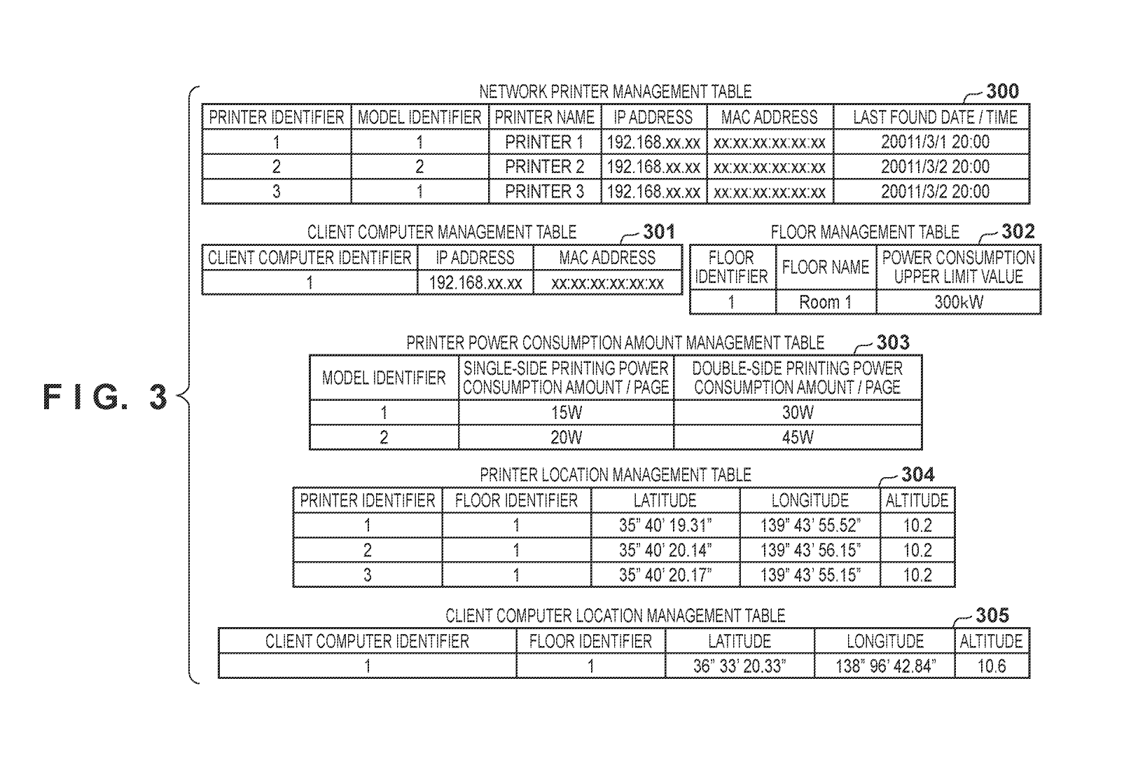

The following describes an example of the configurations of tables in the database server service module 217 with reference to FIG. 3. Note that the table configurations shown in FIG. 3 are merely examples, and table configurations that are different from these examples may be used.

The network printer management table 300 is a table for managing information regarding the network printer 140, which is managed by the network printer management application 212. Examples of the information managed by the network printer management table 300 include a printer identifier, a model identifier, a printer name, an IP address, a MAC address, and a last found date/time. Here, the printer identifier is an identifier that uniquely identifies the network printer 140, and the model identifier is an identifier that uniquely identifies the product model of the network printer 140. The last found date/time is information indicating the date/time when the network printer management application 212 last found the network printer 140.

A client computer management table 301 is a table for managing information regarding the client computer 130, which is managed by the network printer management application 212. Examples of the information managed by the client computer management table 301 include a client computer identifier, an IP address, and a MAC address. Here, the client computer identifier is an identifier that uniquely identifies the client computer 130.

A floor management table 302 is a table for managing a power consumption upper limit value with respect to the floor on which the network printer 140 is installed. Examples of the information managed by the floor management table 302 include a floor identifier, a floor name, and a power consumption upper limit value. Here, the floor identifier is an identifier that uniquely identifies the floor, and the power consumption upper limit value is the upper limit value of the power consumption amount that is permitted for the network printer 140 on the floor in a certain time period.

A printer power consumption amount management table 303 is a table for managing, for each product model, a predicted value for the amount of power consumed when the network printer 140 executes a print job in accordance with respective print settings. Examples of the information managed by the printer power consumption amount management table 303 include a model identifier, a single-side printing power consumption amount, and a double-side printing power consumption amount. Here, the model identifier is an identifier that uniquely identifies the product model of the network printer 140. The printer power consumption amount management table 303 may also manage predicted values for the power consumption amount in other print settings.

The printer location management table 304 is a table for managing the installation location of the network printer 140. Examples of the information managed by the printer location management table 304 include a printer identifier, a floor identifier, and an installation location including a latitude, a longitude, an altitude, and the like. Here, the printer identifier is an identifier that uniquely identifies the network printer 140, and the floor identifier is an identifier that uniquely identifies the floor.

The client computer location management table 305 is a table for managing the installation location of the client computer 130. Examples of the information managed by the client computer location management table 305 include a client computer identifier, a floor identifier, and an installation location including a latitude, a longitude, an altitude, and the like. Here, the client computer identifier is an identifier that uniquely identifies the client computer 130, and the floor identifier is an identifier that uniquely identifies the floor.

Returning to FIG. 2, the following describes the software configuration of the client computer 130. The modules in FIG. 2 are stored as files in the external memory 110. These modules are program modules that are loaded to the RAM 102 at the time of execution and then executed by the OS or module that is to use them. Also, an application 220, a printer driver 222, and the web browser 225 can be added to the external memory 110 via a CD-ROM (not shown) or the network 160. The application 220 stored in the external memory 110 is loaded to the RAM 102 and then executed.

The application 220 is an application for printing documents, images, and the like, and transmits document information, image information, and the like to the printer driver 222 as print data. A graphics engine 221 performs screen rendering. Normally, the graphics engine 221 is often a function that the OS of the client computer 130 is provided with, but it may be a function that the application 220 is separately provided with. The printer driver 222 performs control with respect to print data. The printer driver 222 converts print data and print settings into a print command (print job) called a PDL (Page Description Language) command, and transmits the print command to the print spooler 223.

The print spooler 223 successively transmits print jobs to the print server 100 via a network module 224. The network module 224 performs network communication with the print server 100 and the application server 120 using an arbitrary communication protocol. The web browser 225 transmits an HTTP request message via the network module 224, receives an HTTP response message, and performs display in accordance with the HTTP response message. Access from the client computer 130 to the application server 120 is performed through the web browser 225.

Next, a description of the software configuration of the network printer 140 will be given. The network printer 140 is configured from a network module 230, a power management module 231, a print job reception module 232, a print job control module 233, a print processing module 234, and the like.

The network module 230 performs network communication with the print server 100 using an arbitrary communication protocol. The power management module 231 acquires the power consumption amount from the power meter I/F 151. The print job reception module 232 receives a print job from the network module 230, and passes the print job to the print job control module 233. The print job control module 233 performs control with respect to the print job, and outputs the print job to the print processing module 234 as a PDL command. The print processing module 234 receives the PDL command from the print job control module 233 and performs print processing.

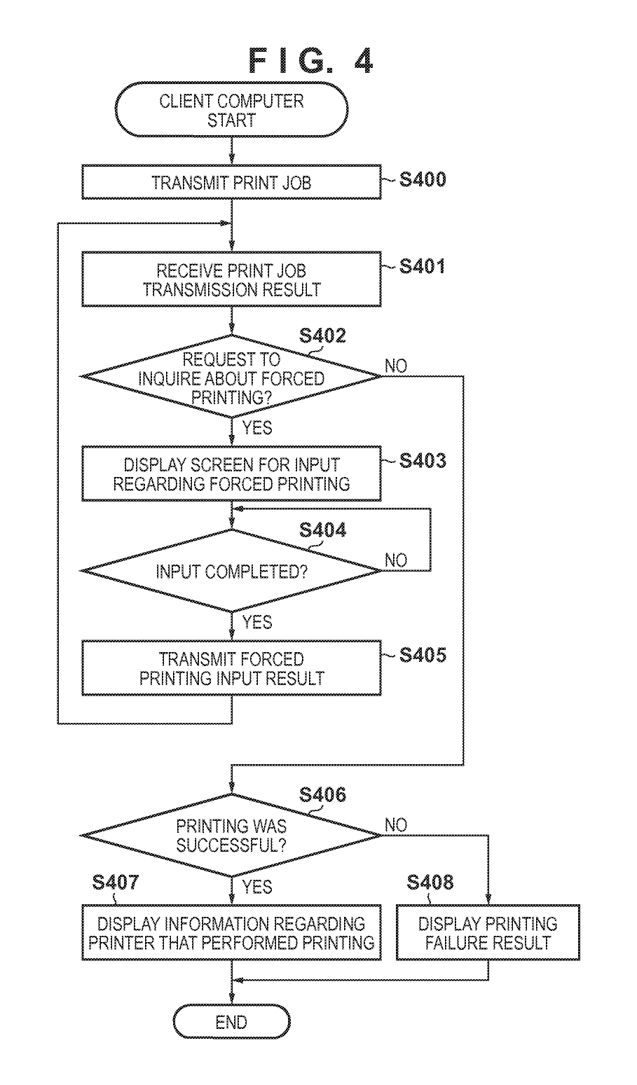

The following describes processing performed when the client computer 130 inputs a print job to the print server 100 in the network printer management system, with reference to the flowchart shown in FIG. 4.

First, in step S400, the print spooler 223 of the client computer 130 transmits a print job that was received from the printer driver 222 to the print server 100. Next, in step S401, the printer driver 222 receives a result regarding the print job (print job transmission result) from the print server 100. In step S402, the printer driver 222 determines whether the print job transmission result that was received is a request to inquire about forced printing. Here, the request to inquire about forced printing is for allowing the user to confirm whether forced printing is to be performed if the network printer 140 that can execute the print job is a certain distance or more away from the client computer 130.

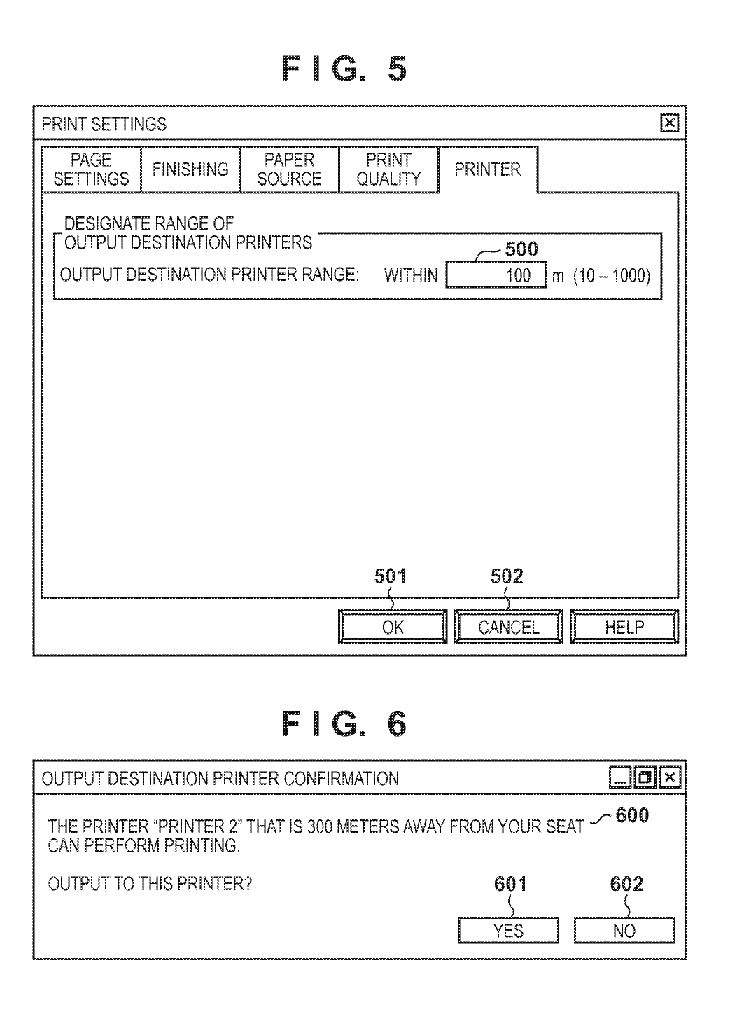

Note that a configuration is possible in which the certain distance (threshold value) used in the determination of whether forced printing is to be performed can be designated via a screen displayed by the printer driver 222. FIG. 5 shows an example of this screen displayed by the printer driver 222. Details of this screen will be described later.

If the printer driver 222 determines in the above-described step S402 that the print job transmission result is a request to inquire about forced printing, the procedure moves to step S403, and in the case of determining that it is not a request to inquire about forced printing, the procedure moves to step S406. In step S403, the printer driver 222 displays a screen for allowing to the user to perform input regarding whether forced printing is to be performed. FIG. 6 shows an example of this screen. Details of this screen will be described later.

Next, in step S404, the printer driver 222 determines whether user input in the forced printing input screen was completed. The procedure moves to step S405 if the determination result is that input was completed, and returns to step S404 if input has not been completed. In step S405, the printer driver 222 transmits the result of the user input performed in the forced printing input screen to the print server 100, and then the procedure returns to step S401.

On the other hand, in S406, the printer driver 222 determines whether printing was successful based on the print job transmission result. Here, the procedure moves to step S407 if printing was successful, and moves to step S408 if printing was not successful.

In step S407, the printer driver 222 displays a screen including information that is contained in the print job transmission result and indicates the network printer 140 to which the print job was transferred, and then ends this procedure. On the other hand, in S408, the printer driver 222 displays a screen including a printing failure result, and then ends this procedure.

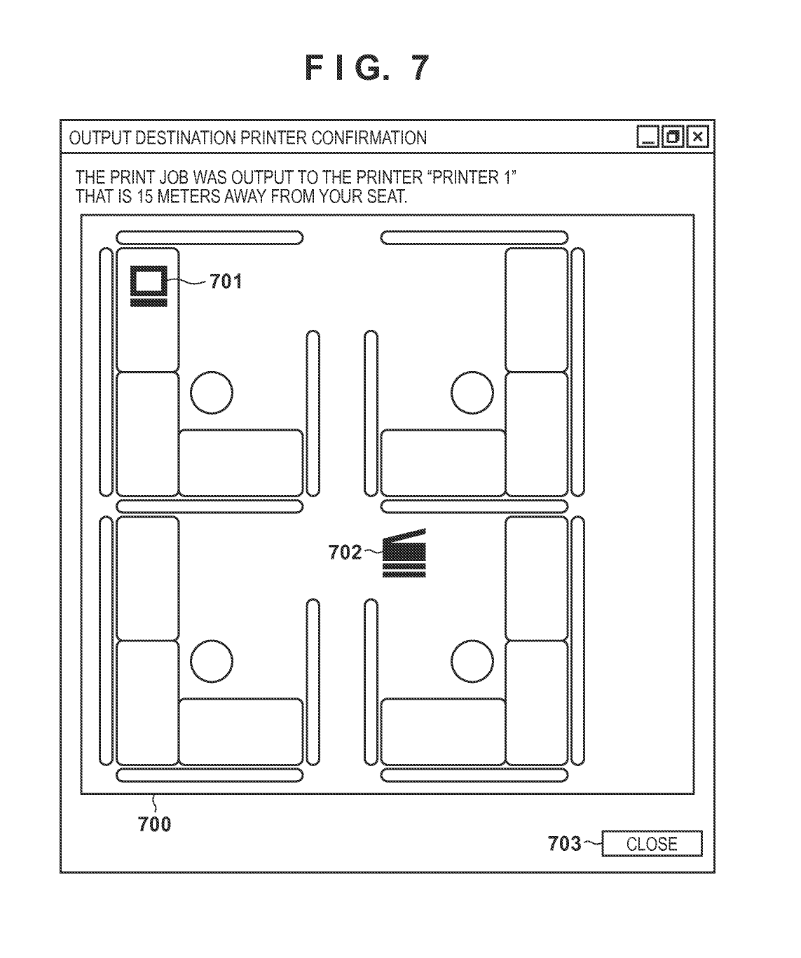

Note that a configuration is possible in which the printer driver 222 acquires the location information of the network printer 140 from the application server 120, and displays a screen indicating the positional relationship with the client computer 130. FIG. 7 shows an example of this screen. Note that details of this screen will be described later.

The following describes examples of the screens displayed by the printer driver 222 in the processing shown in FIG. 4 that is performed by the client computer 130. First, in the screen example shown in FIG. 5, a threshold value input text box 500 is an area in which the user inputs the threshold value that is to be used in the determination of whether forced printing is to be performed. If an OK button 501 is clicked, the value that was input in the threshold value input text box 500 is set as the threshold value, and print setting is completed. If a cancel button 502 is clicked, this print setting is completed without setting the threshold value.

Next, in the screen example shown in FIG. 6, the device information of the network printer 140 targeted for forced printing is displayed in a device information display area 600. If a button 601 or 602 is clicked, the procedure moves to step S405, in which the printer driver 222 transmits the user input result to the print server 100.

Next, in the screen example shown in FIG. 7, a floor map 700 illustrating the floor on which the client computer 130 and the network printer 140 are installed is displayed. Here, a client computer icon 701 is an icon indicating the installation location of the client computer 130 on the floor. Also, a network printer icon 702 is an icon indicating the installation location of the network printer 140 to which the print job was transferred. This display allows the user to visually recognize the distance between the client computer 130 and the installation location of the network printer 140 that executed the print job. This screen is then closed if a close button 703 is clicked.

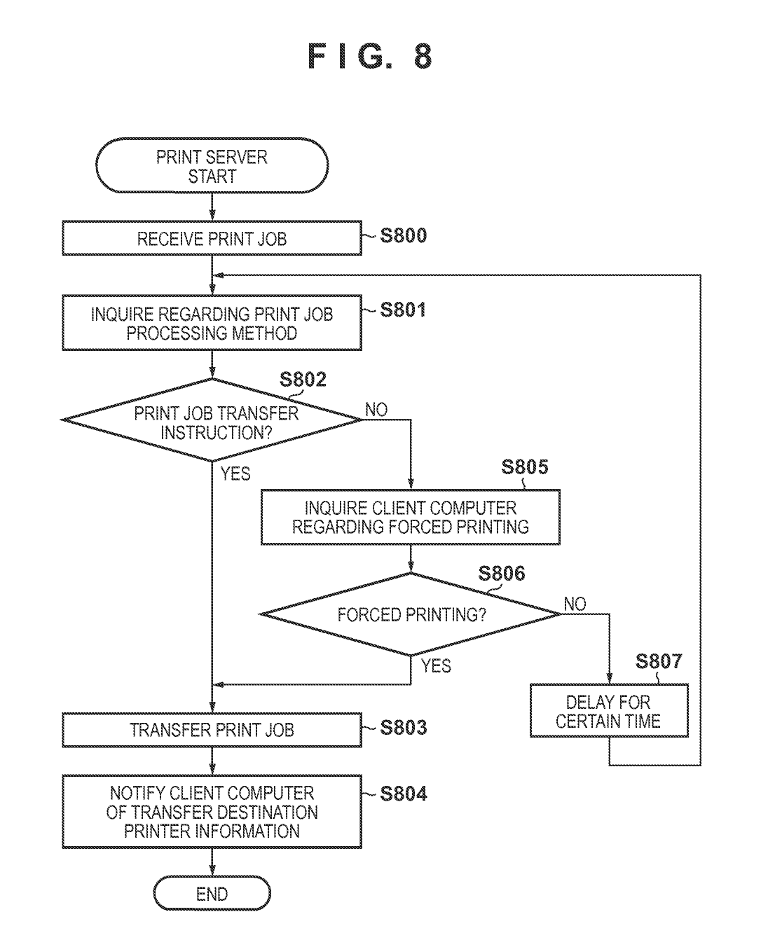

The following describes processing performed when the print server 100 has received a print job that was transmitted from the client computer 130, with reference to the flowchart shown in FIG. 8. First, in step S800, the print job reception unit 201 of the print server 100 receives a print job that was transmitted from the printer driver 222 of the client computer 130, and sends the received print job to the printer driver 203. Next, in step S801, the printer driver 203 makes an inquiry, via the network module 200, to the application server 120 regarding the print job processing method (which network printer the print job is to be transferred to). In step S802, based on a response from the network printer management application 212 of the application server 120, the printer driver 203 determines whether a network printer has been specified as the transfer destination. The case where a network printer has been specified as the print job transfer destination is the case where it was determined that the network printer power consumption amount and the distance from the user's seated location satisfy a predetermined condition, and the procedure moves to step S803 in this case. On the other hand, the case where a network printer has not been specified is the case where there the network printer power consumption amount and the distance from the user's seated location do not satisfy the predetermined condition, and the procedure moves to step S805 in this case.

In step S803, the printer driver 203 transfers the print job to the transfer destination network printer (140 in this example) that was specified by the network printer management application 212 of the application server 120. In step S804, the printer driver 203 notifies the client computer 130 of the device information of the transfer destination network printer 140. The device information of the network printer 140 of which the client computer 130 is notified is, for example, information stored in the network printer management table 300 and the printer location management table 304.

On the other hand, in step S805, the printer driver 203 requests the client computer 130 to inquire whether forced printing is to be performed. In step S806, the printer driver 203 determines whether forced printing is to be performed, based on the response result from the client computer 130. Here, the procedure moves to above-described step S803 if forced printing is to be performed, and moves to step S807 if forced printing is not to be performed. In step S807, the printer driver 203 delays processing for an arbitrary time (certain time), and thereafter returns to the processing of step S801 and again makes an inquiry to the application server 120 regarding the print job processing method. This raises the possibility of being able to specify a network printer that previously could not be specified, but now satisfies the above-mentioned condition and can execute the print job.

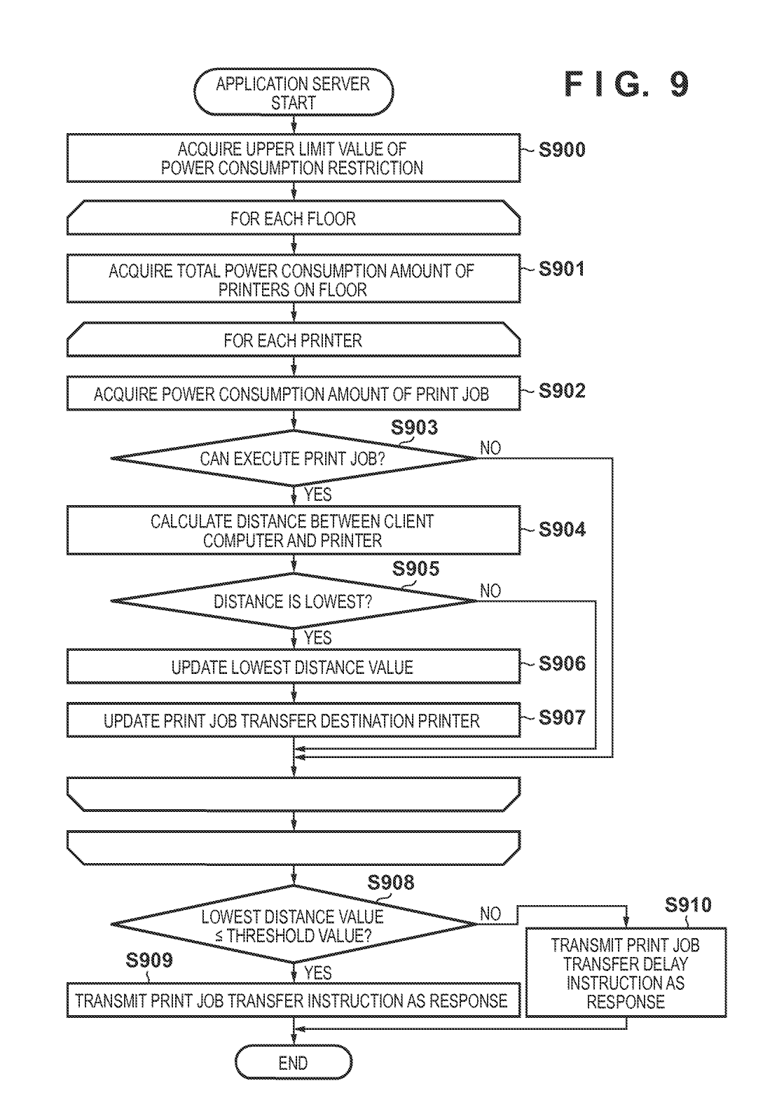

Lastly, the following describes processing performed by the application server 120 when an inquiry regarding the print job processing method is received from the print server 100, with reference to the flowchart shown in FIG. 9. First, in step S900, the power management module 215 acquires the upper limit value of the power consumption restriction for each floor from the floor management table 302 in the database server service module 217. The processing of steps S901 to S907 is then executed for each floor.

In step S901, the power management module 215 acquires the total power consumption amount of all the network printers 140 on the floor. Here, the information regarding the network printers 140 on the floor is acquired based on the network printer management table 300, the floor management table 302, and the printer location management table 304 in the database server service module 217. Also, the power consumption amounts of the network printers 140 are acquired from the power management modules 231 of the network printers 140 via the network 160. The processing of steps S902 to S907 is then executed for each device on the floor.

In step S902, the power management module 215 acquires a predicted value for the power consumption amount in the case where the corresponding network printer 140 executes the print job. Here, the predicted value for the power consumption amount in the case of executing the print job is calculated by acquiring information from the network printer management table 300 and the printer power consumption amount management table 303 in the database server service module 217. In step S903, the power management module 215 determines whether the print job can be executed by the corresponding network printer 140 based on the information acquired in steps S900, S901, and S902. This processing is processing for, for example, determining whether the total power consumption amount of the network printers 140 on the floor will not exceed the upper limit value of the power consumption restriction even if the corresponding network printer 140 executes the print job.

If the result of the determination in step S903 is that execution is not possible, processing with respect to the corresponding network printer 140 is ended, the procedure returns to step S902, and processing is performed with respect to the next network printer 140. On the other hand, if the print job can be executed, the procedure moves to step S904, in which the location management module 216 calculates the distance between the network printer 140 and the client computer 130 that input the print job. At this time, the location of the client computer 130 is acquired from the client computer location management table 305 in the database server service module 217. Also, the location information of the network printer 140 is acquired from the printer location management table 304 in the database server service module 217.

Next, in step S905, the location management module 216 determines whether the distance between the network printer 140 and the client computer 130 that input the print job, which was calculated in step S904, is less than the lowest value that has been calculated so far. Here, if the distance is less than the lowest value, the procedure moves to step S906, in which the location management module 216 updates the lowest distance value, and then in step S907, the location management module 216 updates the print job transfer destination to the corresponding network printer 140. On the other hand, if the distance is not less than the lowest value, processing with respect to the corresponding network printer 140 is ended, the procedure returns to step S902, and processing is performed with respect to the next network printer 140.

The above processing is performed with respect to all of the network printers on all of the floors. Thereafter, in step S908, the location management module 216 determines whether the lowest distance value is less than or equal to an arbitrary threshold value. The procedure moves to step S909 if the lowest distance value is less than or equal to the threshold value, and moves to step S910 if it is not less than or equal to the threshold value. In step S909, the location management module 216 transmits, to the print server 100 as a response, a job transfer instruction regarding the network printer 140 to which the print job is to be transferred. On the other hand, in step S910, the location management module 216 transmits, to the print server 100 as a response, a job transfer delay instruction regarding the network printer 140 to which the print job is to be transferred.

According to the above processing, upon receiving a print job, the print server 100 transfers the print job to a network printer 140 that can perform printing and whose distance from the client computer 130 is less than or equal to an arbitrary threshold value. Note that if no network printer 140 can perform printing and is at a distance less than or equal to the arbitrary threshold value, the user confirms whether forced printing is to be performed, and then print job transfer is delayed until a network printer 140 is able to perform printing. Accordingly, it is possible to select a printer and output a print job to the selected printer while realizing a reduction in the peak amount of network printer power consumption and also taking into consideration the distance from the user's seated location.

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-025534, filed Feb. 8, 2012, which is hereby incorporated by reference herein in its entirety.

What is claimed is:

1. A network printer management apparatus comprising:
a reception unit that receives, from a print server, an inquiry regarding whether there exists a network printer that can execute a print job that was transmitted from a client computer;
a specification unit that specifies a network printer that can execute the print job and for which the distance from the client computer and a network printer power consumption amount satisfy a predetermined condition; and
an instruction unit that, if a network printer was specified by said specification unit, instructs the print server to transfer the print job to said network printer, and if a network printer was not specified by said specification unit, instructs the print server to delay the transfer of the print job.

2. The network printer management apparatus according to claim 1, wherein the predetermined condition is that a total power consumption amount does not exceed an upper limit value of a power consumption restriction if the network printer executes the print job, and that the distance between the network printer and the client computer is less than or equal to a threshold value.

3. The network printer management apparatus according to claim 2, wherein the upper limit value of the power consumption restriction is predetermined for each floor on which a plurality of network printers are installed.

4. The network printer management apparatus according to claim 1, wherein if the instruction unit instructed the delay of the transfer of the print job, the print server is caused to make an inquiry regarding whether the client computer is to specify a network printer that can execute the print job.

5. A network printer management system including the network printer management apparatus according to claim 1, a client computer, and a plurality of network printers, all of which are connected via a network.

6. A method for controlling a network printer management apparatus, comprising:
receiving, from a print server, an inquiry regarding whether there exists a network printer that can execute a print job that was transmitted from a client computer;
specifying a network printer that can execute the print job and for which the distance from the client computer and a network printer power consumption amount satisfy a predetermined condition; and
if a network printer was specified, instructing the print server to transfer the print job to said network printer, and if a network printer was not specified, instructing the print server to delay the transfer of the print job.

7. A non-transitory computer-readable medium storing a program for causing a network printer management method to be executed by a computer, the method comprising:
receiving, from a print server, an inquiry regarding whether there exists a network printer that can execute a print job that was transmitted from a client computer;
specifying a network printer that can execute the print job and for which the distance from the client computer and a network printer power consumption amount satisfy a predetermined condition; and
if a network printer was specified, instructing the print server to transfer the print job to said network printer, and if a network printer was not specified, instructing the print server to delay the transfer of the print job.
